(19) United States
(12) Patent Application Publication
(10) Pub. No.: US 2002/0167775 A1
(43) Pub. Date: Nov. 14, 2002

(54) Overvoltage protection element and overvoltage protection means

(75) Inventors: Martin Wetter, Detmold (DE); Joachim Wosgien, Lohne (DE); Rainer Durth, Horn-Bad Meinberg (DE)

Correspondence Address: NIXON PEABODY, LLP, 8180 GREENSBORO DRIVE, SUITE 800, MCLEAN, VA, 22102, US

(73) Assignee: Phoenix Contact GmbH & Co. KG, Blomberg (DE)

(21) Appl. No.: 10/114,327

(22) Filed: Apr. 3, 2002

(30) Foreign Application Priority Data
Apr. 3, 2001 (DE) 101 16 622.2
Apr. 26, 2001 (DE) 101 20 563.5

(51) Int. Cl. H02H 1/00

(52) U.S. Cl. 361/117

(57) ABSTRACT

An over-voltage protection element for limiting transient over-voltages and for discharging transient currents which includes at least two electrodes defining a spark gap in which an arc is formed when the over-voltage protection element is initiated. Each of the electrodes is composed of a conductive ceramic material.

### BACKGROUND OF THE INVENTION

1. Field of the Invention

The invention relates to an over-voltage protection element for limiting transient over-voltages and for discharging of transient currents which has at least two electrodes and a spark gap which is present between the electrodes, so that when the spark gap is initiated an arc forms between the first electrode and the second electrode. In addition, the invention relates to a over-voltage protection means including a first electrode, a second electrode, a spark gap between the electrodes, and a housing which holds the electrodes, so that when the spark gap is initiated an arc forms between the first electrode and the second electrode.

2. Description of Related Art

Electrical devices such as telecommunications means and systems, as well as electronic measurement, control, and switching circuits, are sensitive to transient over-voltages, which can occur due to atmospheric discharges, switching operations, or short circuits in power supply grids. This sensitivity to over-voltages has increased to the degree in which electronic components, such as integrated circuits, i.e., transistors and thyristors, are greatly endangered by transient over-voltages.

Normally electrical circuits operate at the voltage specified for them, that is, the rated voltage, without problems. This does not apply when over-voltages occur. Over-voltages are considered to be all voltages which are above the upper tolerance limit of the rated voltage. They mainly include transient over-voltages caused by atmospheric discharges, but they can also be due to switching operations or short circuits in power supply grids, and be conductively, inductively or capacitively coupled into electrical circuits. In order to protect electrical circuits, especially electronic measurement, control, and switching circuits such as telecommunications means and systems, against transient over-voltages, over-voltage protection means have been developed and have been in use for more than twenty five years, see for example, German patents DE 41 41 681, DE 42 44 051 or DE 44 02 615.

An important component of over-voltage protection means is at least one spark gap which responds at a certain over-voltage, i.e., the sparkover voltage, and thus prevents over-voltages which are greater than the sparkover voltage of the spark gap from occurring in the circuit to be protected.

When the spark gap is initiated, an arc which forms which causes a low-impedance connection between the two electrodes. Consequently, at the prevailing line voltage an unwanted line follow current will follow via the over-voltage protection means; therefore, an effort should be made to extinguish the arc as quickly as possible after the completed discharge process. One alternative for achieving this is to increase the arc length and thus the arc voltage. This alternative is implemented in the over-voltage protection means disclosed in German Patent DE 44 02 615 C2. The arc voltage can also be increased by raising the pressure in the closed, pressure-tight housing holding the over-voltage protection means. Another possibility for extinguishing the arc is to cool the arc by the cooling action of insulation walls and by using insulators which release gas. In this alternative, a strong flow of extinguishing gas is necessary which requires a major construction effort. In addition, the line follow current can be limited by inserting a series resistor into the discharge path or can be limited by series connection of several spark gaps and the resulting addition of the individual arc voltages, as is shown in published German Patent Application DE 197 42 302 A1.

As was stated initially, the over-voltage protection element or the over-voltage protection means of the invention has two electrodes and a spark gap between the electrodes. A spark gap generally includes both a breakdown spark gap and also a flashover spark gap in which a creeping discharge occurs. A breakdown spark gap can include an air breakdown spark gap and a gas breakdown spark gap in which a gas, other than air, is present between the electrodes.

Over-voltage protection means including a breakdown spark gap, when compared to those with a flashover spark gap, have the advantage of a greater current carrying capacity, but also a disadvantage of a higher and not necessarily constant sparkover voltage. Therefore, different over-voltage protection means with a breakdown spark gap have been proposed which have an improved sparkover voltage. Further, initiation aids positioned in the area of the breakdown spark gap between the electrodes have been implemented in different ways, for example, by providing between the electrodes an initiation aid, made of plastic and contructed as a crosspiece, which triggers a creeping discharge and which projects at least partially into the breakdown spark gap.

Overall, there are known a host of different over-voltage protection elements and over-voltage protection means each of which are made differently depending on the location of their use and the demands imposed on them. There are also a host of different embodiments of spark gaps and electrodes, particularly with respect to the arrangement and geometrical dimension of the electrodes. Additionally, the distance between the electrodes can also be chosen to be of different sizes. Thus, there are over-voltage protection elements in which the distance between the electrodes is small such that the electrodes almost touch or do in-fact touch. The spark gap is in those situations in the microscopic range and is dictated essentially by the surface roughness of the electrodes.

In addition to the known embodiment where the electrodes are shaped as arcing horns, making the first electrode as a rod-shaped or truncated cone-shaped middle electrode is also known. In this embodiment, the second electrode can be a cylindrical outside electrode and located concentrically around the first electrode, see published German Patent Application DE 100 08 764 A1. Published German Patent Application DE 198 18 674 A1 also discloses electrodes in a parallel arrangement to one another where the two electrodes are each cylindrical. In addition, over-voltage protection elements are also known in which the electrodes are made as flat round disks and the electrodes are located opposite one another. With this arrangement of the electrodes, called a disk spark gap, it is also possible to use more than two electrodes, for example, see published German Patent Application DE 197 42 302 A1.

Regardless of the specific geometrical configuration and arrangement of the electrodes, the electrodes of the known over-voltage protection elements are made almost exclusively of metals such as copper or tungsten-copper. After stress, i.e., after initiation of the spark gap, the electrode surfaces exhibit signs of fusion as a result of the lightning stroke current. In addition, a metallic vapor often forms on the surface of adjacent insulation arrangements. These effects reduce the service life of the electrodes and thus the serviceability of the over-voltage protection element or over-voltage protection means. To diminish these defects, it has already been proposed, see German Patent DE 197 42 302, that the electrodes be made of graphite. When using graphite electrodes there is no metal burn-up so that the electrodes and thus the over-voltage protection element still work relatively reliably even after several responses. However, the disadvantage of these known over-voltage elements is that electrodes of copper or tungsten-copper are relatively expensive; while graphite electrodes can burn and have relatively low mechanical strength.

### SUMMARY OF THE INVENTION

The primary object of this invention is to provide an over-voltage protection element and an over-voltage protection means that works reliably with repeated response of the spark gap and still can be produced as simply and economically as possible.

The over-voltage protection element or the over-voltage protection means of the invention is essentially characterized first of all by an electrode composed of a conductive ceramic material. The invention does not involve improving the known over-voltage protection elements by further optimization of the arrangement and geometry of the electrodes, but instead employs a material other than the tungsten-copper or graphite which is used almost exclusively for the electrodes.

Electrodes of conductive ceramic material are on the one hand much more economical than tungsten-copper electrodes, while on the other hand they have high mechanical and thermal strength which leads to a very long service life for the electrodes. Additionally, burn-up upon initiation is extremely low. Finally, the electrical conductivity of the electrodes can be adjusted within wide limits by the proper choice of ceramic mixtures so that desirable resistance properties of the electrodes, e.g., considering the limitation of line follow currents, can be achieved.

Advantageously, the conductive ceramic material is based on a ceramic material which contains at least one metal and/or at least one conductive metal compound. By suitable selection of the metal or metal compound the electrical conductivity of the ceramic can be easily adjusted. The conductive ceramic material is preferably based on cermets which are also called metal ceramics. Cermets include the group of materials which are composed of one metal and one ceramic component. Usually, the ceramic powder is mixed with a metal powder, pressed into formed bodies under high pressure, sintered, ground and then shaped as desired by press forming under high pressure.

According to another embodiment of the invention, the conductive ceramic material can be selected from conductive metal oxides, conductive metal carbides, conductive metal borides, conductive metal silicides, conductive metal nitrides and/or silicon. Of course, the conductive ceramic material can also be based on mixtures of the aforementioned materials.

According to one alternative embodiment, the conductive ceramic material does not include conductive ceramics, but instead includes inherently nonconductive ceramics to which conductive components are added. In particular, the conductive ceramic material can be based on nonconductive metal oxides, nonconductive metal carbides, nonconductive metal borides, nonconductive metal silicides, or nonconductive metal nitrides to which at least one conductive component is added. The conductive component is chosen from the group of conductive metal oxides, conductive metal carbides, conductive metal borides, conductive metal silicides, and conductive metal nitrides and mixtures thereof. The conductive component however need not be a metal or conductive metal compound, but can also be graphite or silicon.

Suitable ceramic materials are especially indium-tin oxide, silicon carbide, boron carbide, titanium boride, zirconium boride, calcium borides, titanium nitride and silicon. The aforementioned materials are conductive ceramics. Examples of mixed ceramics composed of nonconductive ceramics and conductive components are the following: zirconium oxide and titanium carbide, aluminum oxide and titanium carbide, boron nitride and titanium boride, silicon and lanthanum chromate.

The current invention is independent of the specific physical embodiment of the over-voltage protection element and the over-voltage protection means, that is, the invention is independent of the arrangement and shape of the electrodes, the configuration of the spark gap or the use of initiation aids. Some preferred embodiments of the over-voltage protection means of the invention will be briefly indicated below.

According to an advantageous embodiment, the over-voltage protection means of the invention has an initiation aid which triggers the spark gap. The initiation aid can have either a breakdown spark gap in which upon response a creeping discharge occurs, or a flashover spark gap, i.e. its own initiation spark gap. Preferably, the initiation aid is made as an “active initiation aid” which has its own breakdown spark gap so that the over-voltage protection means has at least a third electrode which is associated with the first electrode and the second electrode such a second spark gap is formed between the first electrode and the third electrode . One such “active initiation aid” having an initiation circuit and a striking voltage output is shown in DE 198 03 636, the disclosure of which is hereby incorporated by reference.

According to another advantageous embodiment of the over-voltage protection means of the invention, in the housing there are a host of arc splitters employed as an extinction aid. With the arrangement of these arc splitters, the over-voltage protection behavior, especially the line follow current extinguishing behavior of the over-voltage protection means, is improved since the arc is broken down into a series of short, cascaded partial arcs and the sum of the partial arcs has a voltage demand which is higher than the undivided arc. The arc splitters advantageously are composed of conductive ceramic material like the electrodes. In this embodiment, the same materials used for producing the electrodes can be used to produce the arc splitters.

In particular, there are a host of possibilities for embodying and developing the over-voltage protection element and the over-voltage protection means of the invention. In this respect, the following description of two preferred embodiments in conjunction with the drawings is set forth.

### BRIEF DESCRIPTION OF THE DRAWINGS

FIG. 1 shows a schematic of an over-voltage protection element with electrodes shaped as arcing horns,

FIG. 2 shows a schematic of an over-voltage protection means with electrodes shaped as arcing horns, and

FIG. 3 shows a schematic of the over-voltage protection means with a truncated cone-shaped middle electrode within a cylindrical outer electrode.

### DETAILED DESCRIPTION OF THE INVENTION

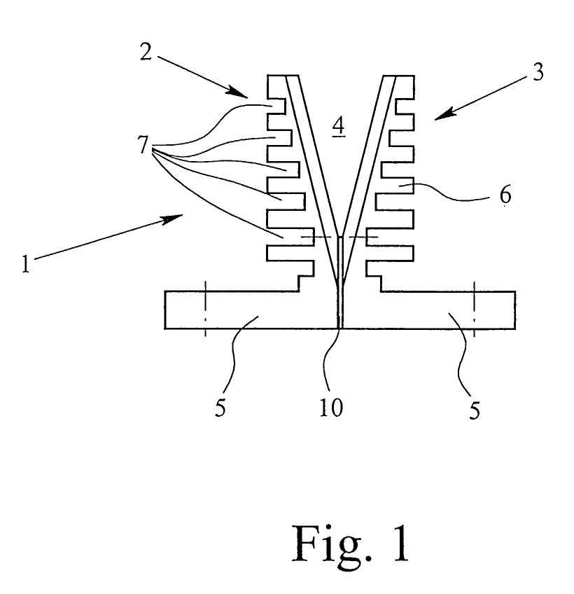

The over-voltage protection element shown in FIG. 1 is used to discharge transient over-voltages and to limit surge currents and includes two electrodes 2, 3 and a spark gap 4 between the electrodes 2, 3. The two electrodes 2, 3 of the invention are composed of conductive ceramic material and each have one connecting leg 5 and an arcing horn 6 which runs at an acute angle to the connecting leg 5. The acute angle between the connecting leg 5 and the arcing horn 6 relates to the working surface of the arcing horn 6. The arcing horns 6 of the two electrodes 2, 3 are located at a distance from one another to form the spark gap 4. Because the arcing horns 6 of the electrodes 2, 3 run at an acute angle to the connecting legs 5, the spark gap 4 is acutely-angled.

The arcing horns 6 can border the connecting legs 5 with a hole 10 running parallel to the connecting legs 5. The hole enables the arc, formed at the moment of initiation next to the hole of the over-voltage protection element 1, to be moved away from its origin by a thermal, electrical, and/or magnetic pressure, as well as by force action.

FIGS. 1 & 2 illustrate the arcing horns 6 of the electrodes 2, 3 as being provided with slots 7 on the sides of the horns 6 facing away from one another. The slots 7 will result in the current exactly duplicating the contour of the V-shaped spark gap 4 as far as the base of the arc.

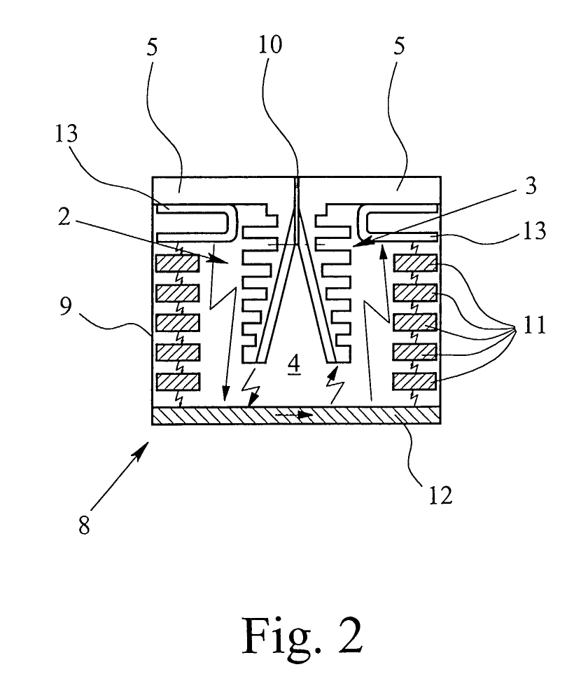

The over-voltage protection means 8 shown in FIG. 2 includes the over-voltage protection element 1 and a housing 9 which holds the over-voltage protection element 1. In addition, there is an initiation aid 10 which triggers a creeping discharge and which is located between the opposing ends of the connecting legs 5 of the two electrodes 2, 3. The initiation aid 10 can include an insulating material and projects slightly into the spark gap 4 formed by the arcing horns 6.

In the over-voltage protection means 8, shown in FIG. 2, within the housing 9 there are a host of arc splitters 11. There are also a host of arc splitters 11 on the sides of the arcing horns 6 of the electrodes 2, 3 on the sides facing away from one another. The embodiment of the over-voltage protection means 8 shown in FIG. 2 also includes a housing cover 12 adjacent to the arcing horns 6 which is composed of a conductive ceramic material. Here the distance between the ends of the arcing horns 6 adjacent to the housing cover 12 and the housing cover 12 is chosen such that arcs can form between the arcing horns 6 and the housing cover 12. As a result, the arc formed after initiation of the over-voltage protection element 1 migrates first out of the initiation area to the tips of the arcing horns 6. Then, two arcs form between the tips of each arcing horn 6 and the housing cover 12 composed of a conductive ceramic material. The conductor loop which builds up doing this now enables the two arcs to be driven behind the arcing horns 6.

FIG. 2 also shows a preferred embodiment of an over-voltage protection means 8 of the invention where the connecting legs 5 of the electrodes 2 are provided with a current loop 13 associated with the arc splitter 11 nearest the connecting leg 5. The housing 9 can have at least one opening, which is not shown here, for pressure equalization of the pressure which forms when the arc is struck.

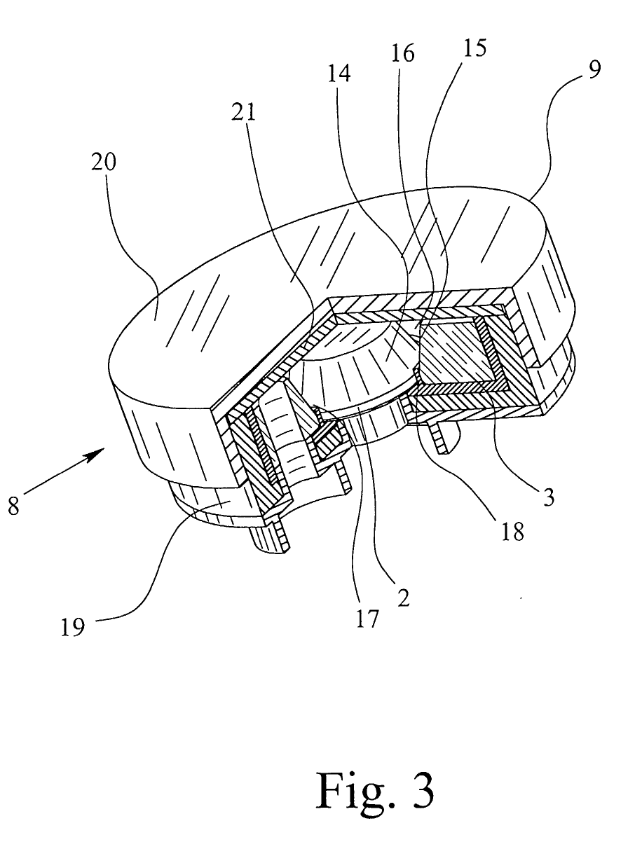

FIG. 3 shows an over-voltage protection means 8 which has a first electrode 2 and a second electrode 3 with one arcing horn 14, 15 each. Between the two arcing horns 14, 15 there is an air breakdown spark gap 16. The two electrodes 2, 3 are therefore space apart from one another and are not connected to one another. Furthermore the over-voltage protection means 8 has a housing 9 which holds the two electrodes 2, 3 . The two arcing horns 14, 15 are made and arranged to one another such that they diverge from the lower initiation area 17 of the air breakdown spark gap 16 to their outer ends. This yields a shape of the air breakdown spark gap 16 which widens continuously to the outside when proceeding from the initiation area 17. In this embodiment, the air breakdown spark gap 16 is V-shaped, and the opening angle of the air breakdown spark gap 16 is roughly 45°. This embodiment of the invention can also encompass smaller opening angles (up to 10°) or larger opening angles (up to 150°).

While the first arcing horn 14 is made in the shape of a truncated cone, the second arcing horn 15 is arranged concentrically around the first arcing horn 14. The over-voltage protection means 8 thus has a rotationally symmetrical structure to its central axis, with the air breakdown spark gap 16 being arranged concentrically around the central axis and opens in the axial direction due to the shape of the electrodes 2, 3.

The second arcing horn 15 of the second electrode 3, is annular, and in order to form the air breakdown spark gap 16 so that it widens in a V-shape, the surface of the second arcing horn 15 facing the first arcing horn 14 is constructed in the shape of a truncated funnel.

In the initiation area 17 of the air breakdown spark gap 16 between the two arcing horns 14, 15, there is a initiation bridge 18 which is used to trigger a creeping discharge. The level of the sparkover voltage can be adjusted by the width of the initiation bridge 18 and/or the height, i.e. over how far the initiation bridge 18 projects into the air breakdown spark gap 16. The initiation bridge 18 which is itself annular and is composed of a gas-releasing plastic.

The housing 9, which can include both of an electrically insulating and also an electrically conductive material, has a housing bottom part 19 and a housing cover 20. Both components have a round shape and are cemented to one another. Finally, as is evident from FIG. 3, the over-voltage protection means 8 can include a baffle plate 21 located at a distance from the ends of the two electrodes 2, 3 adjacent the widest portion of the air breakdown spark gap.

What is claimed is:

1. An over-voltage protection element for limiting transient over-voltages and discharging transient currents comprising:
at least two electrodes positioned relative to another to form a spark gap therebetween,
wherein the electrodes are composed of a conductive ceramic material.

2. The over-voltage protection element as set forth in claim 1, wherein the conductive ceramic material comprises a ceramic material composed of at least one metal and/or at least one conductive metal compound.

3. The over-voltage protection element as set forth in claim 1, wherein the conductive ceramic material is a cermet.

4. The over-voltage protection element as set forth in claim 1, wherein the conductive ceramic material includes compounds selected from the group consisting of conductive metal oxides, conductive metal carbides, conductive metal borides, conductive metal silicides, conductive metal nitrides and silicon.

5. The over-voltage protection element as set forth in claim 1, wherein the conductive ceramic material includes compounds selected from the group consisting of nonconductive metal oxides, nonconductive metal carbides, nonconductive metal borides, nonconductive metal silicides, or nonconductive metal nitrides, and includes at least one conductive compound selected from the group consisting of conductive metal oxides, conductive metal carbides, conductive metal borides, conductive metal silicides, conductive metal nitrides and mixtures thereof.

6. The over-voltage protection element as set forth in claim 1, wherein each electrode includes a connecting leg and an arcing horn which extends at an acute angle to the connecting leg wherein the arcing horns are spaced from each other to form the spark gap.

7. An over-voltage protection means for limiting transient over-voltages and discharging transient currents comprising:
at least two electrodes positioned relative to one another to form a spark gap therebetween,
a housing for supporting the electrodes,
wherein the electrodes are composed of a conductive ceramic material.

8. The over-voltage protection means as set forth in claim 7, including an initiation aid to trigger the initiation of an arc in the spark gap.

9. The over-voltage protection means as set forth in claim 8, which further includes a third electrode associated with the first electrode and the second electrode to form a second spark gap between the first electrode and the third electrode.

10. The over-voltage protection means as set forth in claim 7, which further includes arc splitters in the housing and wherein the arc splitters constitute extinquishing aids.

11. The over-voltage protection means as set forth in claim 10, wherein the arc splitters are composed of a conductive ceramic material.

12. The over-voltage protection means as set forth in claim 7, wherein the at least two electrodes each have an arcing horn, and wherein the housing is composed of a conductive ceramic material and is positioned in spaced apart relationship from the arcing horns.

13. The over-voltage protection means as set forth in claim 12, wherein the housing has a baffle plate composed of conductive ceramic material positioned in opposition to the arching horns.

14. The over-voltage protection means as set forth in claim 7, wherein the at least two electrodes each have an arcing horn, and wherein the housing has a baffle plate composed of conductive ceramic material positioned in opposition to the arching horns.

15. The over-voltage protection means as set forth in claim 7, wherein the housing includes at least one opening which enables pressure equalization.
